(19) United States
(12) Patent Application Publication
(10) Pub. No.: US 2010/0183918 A1
(43) Pub. Date: Jul. 22, 2010

(54) Nonaqueous electrolytic solution battery

(75) Inventors: Shinya Wakita, Fukushima (JP); Izaya Okae, Fukushima (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/657,355

(22) Filed: Jan. 19, 2010

(30) Foreign Application Priority Data
Jan. 22, 2009 (JP) P2009-012194

(51) Int. Cl. H01M 6/14

(52) U.S. Cl. 429/207

(57) ABSTRACT

A nonaqueous electrolytic solution composition includes: an ambient temperature molten salt in an amount of not more than 1.0% by mass relative to the total of negative electrode active materials.

### CROSS-REFERENCE TO RELATED APPLICATION

The present application claims priority from Japanese Patent Application No. JP 2009-012194 filed in the Japanese Patent Office on Jan. 22, 2009, the entire content of which is incorporated herein by reference.

### BACKGROUND OF THE INVENTION

1. Field of the Invention

The present invention relates to a battery and an electrolytic solution each containing an ambient temperature molten salt.

2. Description of the Related Art

In recent years, downsizing and weight saving of portable electronic appliances represented by a mobile phone, PDA (personal digital assistant) and a laptop personal computer have been actively promoted. As a part thereof, an enhancement in energy density of a battery as a driving power source for such an electronic appliance, in particular, a secondary battery has been eagerly desired.

As a secondary battery capable of obtaining a high energy density, there are known, for example, secondary batteries using lithium (Li) as an electrode reactant. Above all, a lithium ion secondary battery using a carbon material capable of intercalating and deintercalating lithium for a negative electrode is widely put into practical use. However, in the lithium ion secondary battery using a carbon material for a negative electrode, technologies have already been developed to an extent close to a theoretical capacity thereof. Thus, as a technique for further enhancing the energy density, there has been studied a method in which the thickness of an active material layer is increased, thereby increasing a proportion of the active material layer within the battery and decreasing a proportion of each of a collector and a separator (see, for example, JP-A-9-204936).

### SUMMARY OF THE INVENTION

However, when the thickness of the active material layer is increased without changing a volume of the battery, the area of the collector relatively decreases. Thus, a current density to be applied to the electrode increases, resulting in an enormous lowering of the cycle characteristic. Consequently, it was difficult to increase the thickness of the active material layer.

Also, when the thickness of the active material layer is increased, or the volumetric density is increased, the cycle characteristic is easily deteriorated due to a lowering of lithium ion acceptance at the interface of a negative electrode active material. Thus, it was difficult to increase the thickness of the active material layer or to increase the volumetric density.

Thus, it is desirable to provide a battery capable of obtaining a high energy density and also obtaining an excellent cycle characteristic.

For the purpose of enhancing the safety, a technique for adding an ambient temperature molten salt to an electrolytic solution is disclosed in, for example, JP-A-2007-141489. However, when a large amount of an ambient temperature molten salt is used for the purpose of enhancing the safety, the battery characteristics are largely lowered due to its high viscosity.

In an electrolytic solution according to an embodiment of the present invention, the content of the ambient temperature molten salt is regulated at not more than 1.0% by mass relative to the total of negative electrode active materials.

(1) A nonaqueous electrolytic solution battery according to one embodiment of the invention includes a positive electrode, a negative electrode and a nonaqueous electrolytic solution, wherein the nonaqueous electrolytic solution contains an ambient temperature molten salt, and the content of the ambient temperature molten salt is not more than 1.0% by mass relative to the total of negative electrode active materials.

(2) A nonaqueous electrolytic solution composition according to another embodiment of the invention contains an ambient temperature molten salt in an amount of not more than 1.0% by mass relative to the total of negative electrode active materials.

In the battery according to the embodiment of the present invention, the electrolytic solution contains the ambient temperature molten salt in an amount of not more than 1.0% by mass relative to the total of negative electrode active materials, and therefore, a decomposed film is adequately formed at the interface of the negative electrode active material, whereby the lithium ion charge acceptance is enhanced. As a result, not only the energy density can be enhanced, but an excellent cycle characteristic can be obtained.

### BRIEF DESCRIPTION OF THE DRAWINGS

FIG. 1 is a sectional view showing the configuration of a secondary battery according an embodiment of the present invention.

FIG. 2 is a sectional view showing enlargedly a part of a wound electrode body in the secondary battery as shown in FIG. 1.

### DESCRIPTION OF THE PREFERRED EMBODIMENTS

Embodiments of the present invention are hereunder described in detail with reference to the accompanying drawings.

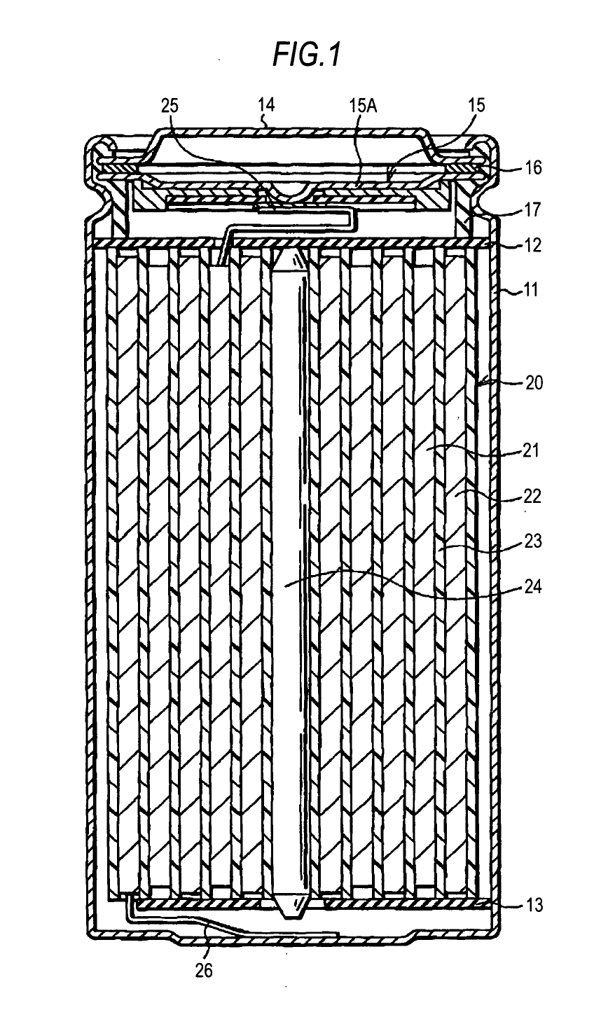

FIG. 1 shows a sectional structure of a secondary battery according to an embodiment of the present invention. This secondary battery is of a so-called cylinder type and has a wound electrode body 20 in which strip-shaped positive electrode 21 and negative electrode 22 are wound via a separator 23 in the inside of a battery can 11 in a substantially hollow column shape. The battery can 11 is constituted of, for example, iron (Fe) plated with nickel (Ni). One end of the battery can 11 is closed, with the other end being opened. A pair of insulating plates 12 and 13 is respectively disposed perpendicular to the winding peripheral face in the inside of the battery can 11 so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed. The battery lid 14 is constituted of, for example, a material the same as that in the battery can 11. The safety valve mechanism 15 is electrically connected to the battery lid 14 via the positive temperature coefficient device 16. In the case where the pressure in the inside of the battery reaches a fixed value or more due to an internal short circuit or heating from the outside or the like, a disc plate 15A is reversed, whereby electrical connection between the battery lid 14 and the wound electrode body 20 is disconnected.

### (Positive Electrode)

A positive electrode active material layer 21B is constituted so as to contain, as a positive electrode active material, a positive electrode material capable of intercalating and deintercalating lithium as an electrode reactant. As the positive electrode material capable of intercalating and deintercalating lithium, lithium-containing compounds, for example, a lithium oxide, a lithium sulfide, an intercalation compound containing lithium and a phosphate compound containing lithium are suitable, and mixtures of plural kinds thereof may also be used. Of these, a complex oxide containing lithium and a transition metal element or a phosphate compound containing lithium and a transition metal element is preferable; and a compound containing at least one of cobalt (Co), nickel, manganese (Mn), iron, aluminum, vanadium (V) and titanium (Ti) as a transition metal element is especially preferable. A chemical formula thereof is represented by, for example, LiₓMIO₂ or Li_{y}MIIPO₄. In the formulae, each of MI and MII includes one kind or plural kinds of transition metal elements; and values of x and y vary depending upon the charge and discharge state of the battery and are usually satisfied with the relationships of (0.05≦x≦1.10) and (0.05≦y≦1.10).

Specific examples of the complex oxide containing lithium and a transition metal element include a lithium cobalt complex oxide (LiₓCoO₂), a lithium nickel complex oxide and a lithium manganese complex oxide having a spinel structure (LiMn₂O₄). Specific examples of the lithium nickel complex oxide include LiNiₓCo₁₋ₓO₂ (0≦x≦1), LiₓNiO₂, LiNiₓCo_{y}O₂ and LiₓNi_{1 z}Co_{z}O₂ (z<1). Specific examples of the phosphate compound containing lithium and a transition metal element include a lithium iron phosphate compound (LiFePO₄) and a lithium iron manganese phosphate compound [LiFe₁₋ᵤMnᵤPO₄ (u<1)].

Also, as the positive electrode material capable of intercalating and deintercalating lithium, other metal compound and a polymer material can be exemplified. Examples of other metal compound include oxides such as titanium oxide, vanadium oxide and manganese dioxide; and disulfides such as titanium sulfide and molybdenum sulfide. Examples of the polymer material include polyaniline and polythiophene.

### (Negative Electrode)

The negative electrode 22 has, for example, a configuration in which a negative electrode active material layer 22B is provided on the both surfaces of a negative electrode collector 22A having a pair of surfaces opposing to each other. While illustration is omitted, the negative electrode active material layer 22B may be provided on only one surface of the negative electrode collector 22A. The negative electrode collector 22A is constituted of a metal foil, for example, a copper foil, a nickel foil, a stainless steel foil, etc.

The negative electrode active material layer 22B is, for example, constituted so as to contain, as a negative electrode active material, one kind or plural kinds of negative electrode materials capable of intercalating and deintercalating lithium as an electrode reactant and may contain, for example, the same conductive agent and binder as in the positive electrode active material layer 21B as described later, if desired.

Examples of the negative electrode material capable of intercalating and deintercalating lithium include carbon materials, for example, graphite, hardly graphitized carbon, easily graphitized carbon, etc. Such a carbon material is preferable because a change in the crystal structure to be generated at the time of charge and discharge is very little, a high charge and discharge capacity can be obtained, and a favorable charge and discharge cycle characteristic can be obtained. In particular, graphite is preferable because it has a large electrochemical equivalent and is able to obtain a high energy density.

As the graphite, one having a true density of 2.10 g/cm³ or more is preferable, and one having a true density of 2.18 g/cm³ or more is more preferable. In order to obtain such a true density, it is necessary that a thickness of a crystallite on the C-axis on the (002) plane is 14.0 nm or more. Also, a lattice spacing of the (002) plane of the graphite is preferably less than 0.340 nm, and more preferably in the range of 0.335 nm or more and not more than 0.337 nm. The graphite may be either natural graphite or artificial graphite.

As the hardly graphitized carbon, one which has a lattice spacing of the (002) plane of 0.37 nm or more and a true density of less than 1.70 g/cm³ and which does not show an exothermic peak at 700° C. or higher in differential thermal analysis (DTA) in air is preferable.

As the negative electrode material capable of intercalating and deintercalating lithium, a negative electrode material which is capable of intercalating and deintercalating lithium and which contains, as a constitutional element, at least one member of a metal element and a semi-metal element is also exemplified. This is because by using such a negative electrode material, a high energy density can be obtained. This negative electrode material may be a simple substance, an alloy or a compound of a metal element or a semi-metal element. Also, one having one kind or plural kinds of phases in at least a part thereof may be used. In the embodiment according to the present invention, the alloy includes, in addition to alloys composed of plural kinds of metal elements, alloys containing one kind or plural kinds of metal elements and one kind or plural kinds of semi-metal elements. Also, the alloy may contain a non-metal element. Examples of its texture include a solid solution, a eutectic (eutectic mixture), an intermetallic compound and one in which plural kinds thereof coexist.

Examples of the metal element or semi-metal element constituting the negative electrode material include magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt), each of which is capable of forming an alloy together with lithium. These may be crystalline or amorphous.

Above all, as the negative electrode material, ones containing, as a constitutional element, a metal element or a semi-metal element belonging to the Group 4B in the short form of the periodic table are preferable, and ones containing, as a constitutional element, at least one of silicon and tin are especially preferable. This is because silicon and tin have large capability for intercalating and deintercalating lithium and are able to obtain a high energy density.

Examples of the alloyed tin include alloys containing, as a second constitutional element other than tin, at least one member selected from the group consisting of silicon, nickel, copper (Cu), iron, cobalt, manganese, zinc, indium, silver, titanium (Ti), germanium, bismuth, antimony (Sb) and chromium (Cr). Examples of the alloyed silicon include alloys containing, as a second constitutional element other than silicon, at least one member selected from the group consisting of tin, nickel, copper, iron, cobalt, manganese, zinc, indium, silver, titanium, germanium, bismuth, antimony and chromium.

Examples of the tin compound or the silicon compound include compounds containing oxygen (O) or carbon (C), and these compounds may contain, in addition to tin or silicon, the foregoing second constitutional element.

At least one of the positive electrode active material layer 21B and the negative electrode active material layer 22B may further contain an ambient temperature molten salt. As the ambient temperature molten salt, compounds as described later can be used.

Each of the positive electrode active material layer 21B and the negative electrode active material layer 22B may contain a conductive agent and a binder, if desired. Examples of the conductive agent include carbon materials such as graphite, carbon black and ketjen black, and these materials are used singly or in admixture of plural kinds thereof. Also, in addition to the carbon material, a metal material or a conductive polymer material or the like may be used so far as it is a material having conductivity.

As the binder, for example, a vinylidene fluoride-containing polymer is preferable. This is because such a polymer has high stability within the battery. Such a binder may be used singly or in admixture of plural kinds thereof.

Examples of the polymer containing vinylidene fluoride as a major component include vinylidene fluoride based polymers or copolymers. Examples of the vinylidene fluoride based polymer include polyvinylidene fluoride (PVdF). Also, examples of the vinylidene fluoride based copolymer include a vinylidene fluoride-hexafluoropropylene copolymer, a vinylidene fluoride-tetrafluoroethylene copolymer, a vinylidene fluoride-carboxylic acid copolymer and a vinylene fluoride-hexafluoropropylene-carboxylic acid copolymer.

### (Separator)

The separator 23 isolates the positive electrode 21 and the negative electrode 22 from each other, prevents a short circuit of current to be caused due to contact of the both electrodes from occurring and allows a lithium ion to pass therethrough. The separator 23 is constituted of, for example, a porous membrane made of a synthetic resin such as polytetrafluoroethylene, polypropylene and polyethylene or a porous membrane made of an inorganic material such as a ceramic-made nonwoven fabric. The separator 23 may also have a porous membrane structure in which two or more kinds of these porous membranes are laminated. Above all, a polyolefin-made porous membrane is preferable because it is excellent in an effect for preventing a short circuit from occurring and is able to contrive to enhance the safety of the battery due to a shutdown effect. In particular, polyethylene is preferable as a material which constitutes the separator 23 because it is able to obtain a shutdown effect within a temperature range of 100° C. or higher and not higher than 160° C. and is excellent in electrochemical stability. Also, polypropylene is preferable. Besides, a resin may be used upon being copolymerized or blended with polyethylene or polypropylene so far as it is provided with chemical stability.

### (Nonaqueous Electrolytic Solution)

An electrolytic solution is impregnated in the separator 23. The electrolytic solution contains, for example, a solvent and an electrolyte salt dissolved in the solvent. Examples of the solvent include carbonate based nonaqueous solvents such as ethylene carbonate, diethyl carbonate, ethyl methyl carbonate, propylene carbonate, dimethyl carbonate, vinylene carbonate and fluoroethyl carbonate. Examples of other solvents include 4-fluoro-1,3-dioxolan-2-one, γ-butyrolactone, γ-valerolactone, 1,2-dimethoxyethane, tetrahydrofuran, 2-methyltetrahydrofuran, 1,3-dioxolan, 4-methyl-1,3-dioxolan, methyl acetate, methyl propionate, ethyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, nitromethane, nitroethane, sulfolane, dimethyl sulfoxide, trimethyl phosphate, triethyl phosphate and ethylene sulfide. Above all, ethylene carbonate, propylene carbonate, vinylene carbonate, dimethyl carbonate, ethyl methyl carbonate and ethylene sulfide are preferable because excellent charge and discharge capacity characteristic and charge and discharge cycle characteristic can be obtained.

Examples of the electrolyte salt include lithium electrolyte salts such as lithium hexafluorophosphate (LiPF₆), lithium bis(pentafluoroethanesulfonyl)imide (Li(C₂F₅SO₂)₂N), lithium perchlorate (LiClO₄), lithium hexafluoroarsenate (LiAsF₆), lithium tetrafluoroborate (LiBF₄), lithium trifluoromethanesulfonate (LiSO₃CF₃), lithium bis(trifluoromethanesulfonyl)imide (Li(CF₃SO₂)₂N), methyl lithium tris(trifluoromethanesulfonyl) (LiC(SO₂CF₃)₃), lithium chloride (LiCl) and lithium bromide (LiBr). Such an electrolyte salt is used singly or in admixture of plural kinds thereof.

The nonaqueous electrolytic solution composition according to the embodiment of the present invention contains an ambient temperature molten salt in an amount of not more than 1.0% by mass, and preferably from 0.3% by mass to 0.8% by mass relative to the mass of the total of negative electrode active materials. This is because a decomposed film is adequately formed at the interface of the negative electrode material, whereby the charge acceptance is enhanced. In the case where the ambient temperature molten salt is contained in an amount of not more than 1% by mass relative to the total of negative electrode active materials, the content of the ambient temperature molten salt in the electrolytic solution is corresponding to not more than 0.5% by mass.

It is preferable that the ambient temperature molten salt contains a tertiary or quaternary ammonium salt composed of, for example, a tertiary or quaternary ammonium cation and a fluorine atom-containing anion. This is because by using the tertiary or quaternary ammonium salt, reductive decomposition of the electrolytic solution as described later can be inhibited. The ambient temperature molten salt may be used singly or in admixture of plural kinds thereof. The tertiary or quaternary ammonium cation also includes one having characteristics of a tertiary or quaternary ammonium cation.

Examples of the quaternary ammonium cation include a cation having a structure represented by the following formula (1).

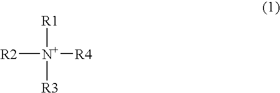

In the formula (1), each of R1, R2, R3 and R4 represents an aliphatic group, an aromatic group, a heterocyclic group or a group in which a part of the elements of any one of these groups is substituted with a substituent. R1, R2, R3 and R4 may be the same or different. Examples of the aliphatic group include an alkyl group and an alkoxyl group. Examples of the alkyl group include a methyl group, an ethyl group, a propyl group, a hexyl group and an octyl group. Examples of the group in which a part of the elements of the aliphatic group is substituted with a substituent include a methoxyethyl group. Examples of the substituent include a hydrocarbon group, a hydroxyalkyl group and an alkoxyalkyl group each having from 1 to 10 carbon atoms.

Examples of the aromatic group include an aryl group.

Examples of the heterocyclic group include pyrrole, pyridine, imidazole, pyrazole, benzimidazole, piperidine, pyrrolidine, carbazole, quinoline, pyrrolidinium, piperidinium and piperazinium.

Examples of the cation having a structure represented by the formula (1) include an alkyl quaternary ammonium cation and a cation in which a part of the functional group or groups of the foregoing cation is substituted with a hydrocarbon group, a hydroxyalkyl group or an alkoxyalkyl group each having from 1 to 10 carbon atoms. As the alkyl quaternary ammonium cation, (CH₃)₃R5N⁺ (R5 represents an alkyl group or an alkenyl group each having from 3 to 8 carbon atoms) is preferable. Examples of such a cation include a trimethylpropylammonium cation, a trimethyloctylammonium cation, a trimethylallylammonium cation, a trimethylhexylammonium cation and an N,N-diethyl-N-methyl-N-(2-methoxyethyl)ammonium cation.

Also, as the tertiary or quaternary ammonium cation other than the cation having a structure represented by the formula (1), a nitrogen-containing heterocyclic cation having a structure represented by any one of the following formulae (2) to (5) is exemplified. The nitrogen-containing heterocyclic cation as referred to herein refers to one having a positive charge on the nitrogen atom constituting a heterocyclic ring as represented by any one of the formulae (2) to (5).

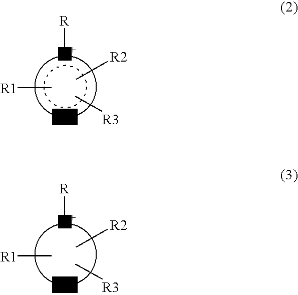

The formula (2) represents a structure having a conjugated bond; and the formula (3) represents a structure not having a conjugated bond. In the formulae (2) and (3), m is from 4 to 5; each of R1, R2 and R3 represents an alkyl group or an alkoxy group each having from 1 to 5 carbon atoms, an amino group or a nitro group and may be the same or different. Also, each of R1, R2 and R3 may be absent. R represents a hydrogen atom or an alkyl group having from 1 to 5 carbon atoms; and the nitrogen atom is a tertiary or quaternary ammonium cation.

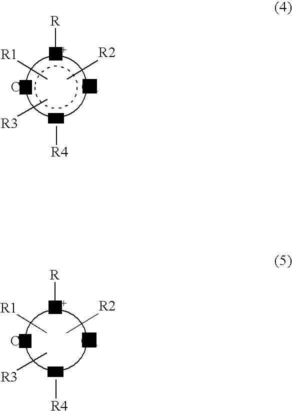

The formula (4) represents a structure having a conjugated bond; and the formula (5) represents a structure not having a conjugated bond. In the formulae (4) and (5), m is from 0 to 2; (m+n) is from 3 to 4; each of R1, R2 and R3 represents an alkyl group or an alkoxy group each having from 1 to 5 carbon atoms, an amino group or a nitro group and may be the same or different. Also, each of R1, R2 and R3 may be absent. R4 represents an alkyl group having from 1 to 5 carbon atoms; R represents a hydrogen atom or an alkyl group having from 1 to 5 carbon atoms; and the nitrogen atom is a tertiary or quaternary ammonium cation.

Examples of the nitrogen-containing heterocyclic cation having a structure represented by any one of the formulae (2) to (5) include a pyrrolium cation, a pyridinium cation, an imidazolium cation, a pyrazolium cation, a benzimidazolium cation, an indolium cation, a carbazolium cation, a quinolinium cation, a pyrrolidinium cation, a piperidinium cation, a piperazinium cation and a cation in which a part of the functional group or groups of any one of these cations is substituted with a hydrocarbon group, a hydroxyalkyl group or an alkoxyalkyl group each having from 1 to 10 carbon atoms.

Examples of such a nitrogen-containing heterocyclic cation include an ethylmethylimidazolium cation and an N-methyl-N-propylpiperidinium cation.

Examples of the fluorine atom-containing anion include BF₄⁻, PF₆⁻, CₙF₂ₙ₊₁CO₂⁻ (n represents an integer of from 1 to 4), CₘF₂ₘ₊₁SO₃⁻ (m represents an integer of from 1 to 4), (FSO₂)₂N⁻, (CF₃SO₂)₂N⁻, (C₂F₅SO₂)₂N⁻, (CF₃SO²)(C₄F₉SO₂)N⁻, (CF₃SO₂)₃C, CF₃SO₂—N—COCF₃ and R5-SO₂—N—SO₂CF₃ (R5 represents an aliphatic group or an aromatic group). Of these, (CF₃SO₂)₂N⁻, (C₂F₅SO₂)₂N⁻ and (CF₃SO₂) (C₄F₉SO₂N⁻ are especially preferable.

As the ambient temperature molten salt composed of a cation having a structure represented by the formula (1) and a fluorine atom-containing anion, one composed of an alkyl quaternary ammonium cation and a fluorine atom-containing anion is especially preferable. Above all, an ambient temperature molten salt using, as the alkyl quaternary ammonium cation, (CH₃)₃R5N⁺ (R5 represents an alkyl group or an alkenyl group each having from 3 to 8 carbon atoms) and, as the fluorine atom-containing anion, (CF₃SO₂)₂N⁻, (C₂F₅SO₂)₂N⁻ or (CF₃SO₂)(C₄F₉SO₂)N⁻ is more preferable. Examples of such an ambient temperature molten salt include trimethylpropylammonium bis(trifluoromethylsulfonyl)imide, trimethyloctylammonium bis(trifluoromethylsulfonyl)imide, trimethylallylammonium bis(trifluoromethylsulfonyl)imide and trimethylhexylammonium bis(trimethylfluorosulfonyl)imide.

In addition to the foregoing, there are exemplified N,N-diethyl-N-methyl-N-(2-methoxyethyl)ammonium bis(trifluoromethylsulfonyl)imide (hereinafter referred to as “DEME•TFSI”), N,N-diethyl-N-methyl-N-(2-methoxyethyl)ammonium tetrafluoroborate (hereinafter referred to as “DEME·BF₄”), N-methyl-N-methoxymethylpyrrolidinium tetrafluoroborate, N-methyl-N-methoxymethylpyrrolidinium bis(trifluoromethylsulfonyl)imide, N-methyl-N-methoxymethylpiperidinium tetrafluoroborate, N-methyl-N-methoxymethylpiperidinium bis(trifluoromethylsulfonyl)imide and N-methyl-N-propylpiperidinium bis(trifluoromethylsulfonyl)imide (hereinafter referred to as “PP13•TFSI”).

### (Manufacturing Method)

The foregoing secondary battery can be, for example, manufactured in the following manner. First of all, a positive electrode active material, a conductive agent and a binder are mixed to prepare a positive electrode mixture. The positive electrode mixture is dispersed in a solvent such as N-methyl-2-pyrrolidone to form a positive electrode mixture slurry in a paste form. Subsequently, the positive electrode mixture slurry is coated on the positive electrode collector 21A, and the solvent is then volatilized. Furthermore, the resultant is compression molded by a roll press or the like to form the positive electrode active material layer 21B. There is thus prepared the positive electrode 21.

Also, a negative electrode active material and a binder are mixed to prepare a negative electrode mixture. The negative electrode mixture is dispersed in a solvent such as N-methyl-2-pyrrolidone to form a negative electrode mixture slurry in a paste form. Subsequently, the negative electrode mixture slurry is coated on the negative electrode collector 22A, and the solvent is then dried. Thereafter, the resultant is compression molded by a roll press or the like to form the negative electrode active material layer 22B. There is thus prepared the negative electrode 22.

Subsequently, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded with the safety valve mechanism 15; and a tip end of the negative electrode lead 26 is welded with the battery can 11. The wound positive electrode 21 and negative electrode 22 are interposed between a pair of the insulating plates 12 and 13 and housed in the inside of the battery can 11. After housing the positive electrode and the negative electrode 22 in the inside of the battery can 11, an electrolytic solution containing an ambient temperature molten salt is injected into the inside of the battery can 11 and impregnated in the separator 23. Thereafter, the battery lid 14, the safety valve mechanism 15 and the positive temperature coefficient device 16 are fixed to the open end of the battery can 11 upon being caulked via the gasket 17. There is thus completed the secondary battery shown in FIG. 1.

In the foregoing secondary battery, when charged, for example, a lithium ion is deintercalated from the positive electrode active material layer 21B and intercalated in the negative electrode active material layer 22B via the electrolytic solution. Also, when discharged, for example, a lithium ion is deintercalated from the negative electrode active material layer 22B and intercalated in the positive electrode active material layer 21B via the electrolytic solution.

While the present invention has been described with reference to the foregoing embodiment, it should not be construed that the present invention is limited thereto, and various modifications can be made. For example, in the foregoing embodiment, the battery using lithium as an electrode reactant has been described. However, the present invention can be applied to the case of using other alkali metal such as sodium (Na) and potassium (K), an alkaline earth metal such as magnesium and calcium (Ca), or other light metal such as aluminum. On that occasion, the positive electrode active material capable of intercalating and deintercalating an electrode reactant and the like are selected depending upon the electrode reactant.

Also, in the foregoing embodiment, the secondary battery of a cylinder type having a winding structure has been specifically described. However, the present invention is similarly applicable to a secondary battery of an oval type or a polygonal type each having a winding structure, or a secondary battery having other shape in which a positive electrode and a negative electrode are folded, or plural positive electrodes and negative electrodes are laminated. In addition, the present invention is similarly applicable to secondary batteries having other shape such as a coin type, a button type, a square type and a laminated film type.

Also, in the foregoing embodiment, the case of using an electrolytic solution in a liquid form as the electrolytic solution has been described. However, an electrolytic solution in a gel form in which an electrolytic solution is held in a holding body such as a polymer compound may be used. Examples of such a polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene and polycarbonate. In particular, polyacrylonitrile, polyvinylidene fluoride, polyhexafluoropropylene and polyethylene oxide are preferable in view of electrochemical stability. A proportion of the polymer compound to the electrolytic solution varies with compatibility therebetween. In general, it is preferable to add the polymer compound in an amount corresponding to 5% by mass or more and not more than 50% by mass of the electrolytic solution.

### Examples

Specific working examples of the present invention are hereunder described in detail.

### Examples 1-1 to 1-5 and Comparative Examples 1-1 to 1-4

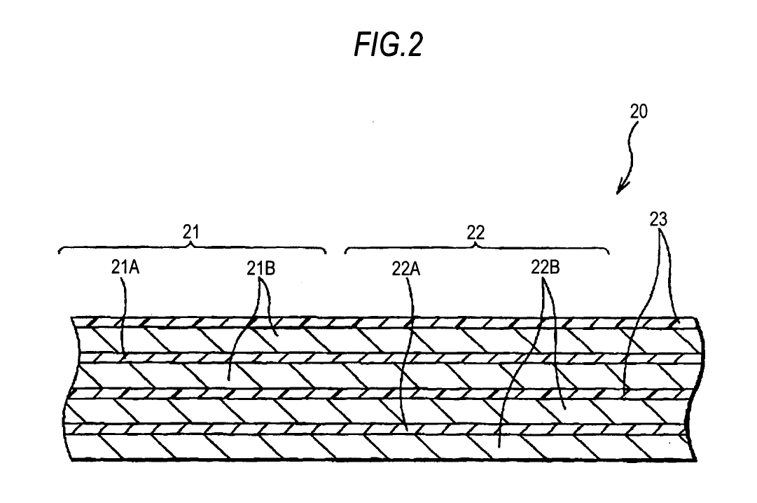

The secondary battery of a cylinder type as shown in FIGS. 1 and 2 was prepared. First of all, lithium carbonate (Li₂CO₃) and cobalt carbonate (CoCO₃) were mixed in a molar ratio of Li₂CO₃/CoCO₃ of 0.5/1, and the mixture was baked in air at 900° C. for 5 hours to obtain a lithium cobalt complex oxide (LiCoO₂). The obtained LiCoO₂ was subjected to X-ray diffraction. The result was well consistent with a peak of LiCoO₂ registered in the JCPDS (Joint Committee of Powder Diffraction Standard) file. Subsequently, this lithium cobalt complex oxide was pulverized to form a positive electrode active material in a powder form having an accumulated 50% particle size obtained by the laser diffraction method of 15 μm.

Subsequently, 95% by mass of this lithium cobalt complex oxide powder and 5% by mass of a lithium carbonate (Li₂CO₃) powder were mixed; 94% by mass of this mixture, 3% by mass of ketjen black as a conductive agent and 3% by mass of polyvinylidene fluoride as a binder were mixed; and the mixture was dispersed in N-methyl-2-pyrrolidone as a solvent to prepare a positive electrode mixture slurry. Subsequently, this positive electrode mixture slurry was uniformly coated on the both surfaces of the positive electrode collector 21A made of a strip-shaped aluminum foil having a thickness of 15 μm and then thoroughly dried at 130° C. The resultant was compression molded to form the positive electrode active material layer 21B, thereby preparing the positive electrode 21. A thickness of one surface of the positive electrode active material layer 21B was 100 μm, and a volume density thereof was 3.52 g/cm³. After preparing the positive electrode 21, the positive electrode lead 25 made of aluminum was installed in one end of the positive electrode collector 21A.

Also, 90% by mass of a granular graphite powder having an average particle size of 25 μm as a negative electrode active material and 10% by mass of polyvinylidene fluoride (PVdF) as a binder were mixed, and the mixture was dispersed in N-methyl-2-pyrrolidone as a solvent to form a negative electrode mixture slurry. Thereafter, this negative electrode mixture slurry was uniformly coated on the both surfaces of the negative electrode collector 22A made of a strip-shaped copper foil having a thickness of 10 μm and then dried. The resultant was compression molded to form the negative electrode active material layer 22B, thereby preparing the negative electrode 22. On that occasion, a thickness of one surface of the negative electrode active material layer 22B was 90 μm, and a volume density thereof was 1.75 g/cm³. After preparing the negative electrode 22, the negative electrode lead 26 made of nickel was installed in one end of the negative electrode collector 22A.

After preparing the positive electrode 21 and the negative electrode 22, respectively, the positive electrode 21 and the negative electrode 22 were laminated via the separator 23 made of a microporous polyethylene film having a thickness of 22 μm. The resulting laminate was wound around a core having a diameter of 3.2 mm, thereby preparing the wound electrode body 20. Subsequently, the wound electrode body 20 was interposed between a pair of the insulating plates 12 and 13; not only the negative electrode lead 26 was welded with the battery can 11, but the positive electrode lead 25 was welded with the safety valve mechanism 15; and the wound electrode body 20 was then housed in the inside of the nickel-plated iron-made battery can 11. Subsequently, an electrolytic solution was injected into the inside of the battery can 11, and the battery lid 14 was caulked with the battery can 11 via the gasket 17, thereby preparing a secondary battery of a cylinder type.

On that occasion, a solution prepared by dissolving, as an electrolyte salt, lithium hexafluorophosphate in a proportion of 1.0 mol/kg in a mixed solvent of ethylene carbonate (EC), diethyl carbonate (DEC) and fluoroethylene carbonate (FEC) in a proportion of 2/1/1 was used as the electrolytic solution.

Furthermore, the electrolytic solution was mixed with Compound 1 (trimethylpropylammonium bis(trifluoromethylsulfonyl)imide) as an ambient temperature molten salt. The addition amount of Compound relative to the mass of the negative electrode active material was changed.

Each of the secondary batteries prepared in Examples 1-1 to 1-5 and Comparative Examples 1-1 to 1-4 was subjected to charge and discharge and examined with respect to a discharge capacity retention rate. On that occasion, the charge was performed at a constant current of 0.7 C until a battery voltage reached 4.2 V and then performed at a constant voltage of 4.2 V until a total charge time reached 4 hours; and the discharge was performed at a constant current of 0.5 C until a battery voltage reached 3.0 V. The term “1 C” as referred to herein represents a current value at which a theoretical capacity is completely discharged within one hour. A ratio of the discharge capacity at the 100th cycle to the discharge capacity at the first cycle, namely [{(discharge capacity at the 100th cycle)/(discharge capacity at the first cycle)}×100 (%)] was defined for the discharge capacity retention rate. The results are shown in Table 1.

TABLE 1

| | | | Amount of ambient | Retention |
|---|---|---|---|---|
| | Composition | Kind of ambient | temperature molten salt | rate after |
| | of organic | temperature | (ratio to negative electrode | 100 cycles |
| | solvent | molten salt | active material) (% by mass) | (%) |
| Example 1-1 | EC/DEC/FEC | Compound 1 | 0.05 | 74 |
| | (2/2/1) | | | |
| Example 1-2 | EC/DEC/FEC | Compound 1 | 0.1 | 80 |
| | (2/2/1) | | | |
| Example 1-3 | EC/DEC/FEC | Compound 1 | 0.5 | 84 |
| | (2/2/1) | | | |
| Example 1-4 | EC/DEC/FEC | Compound 1 | 0.8 | 83 |
| | (2/2/1) | | | |
| Example 1-5 | EC/DEC/FEC | Compound 1 | 1.0 | 77 |
| | (2/2/1) | | | |
| Comparative | EC/DEC/FEC | Compound 1 | 0 | 69 |
| Example 1-1 | (2/2/1) | | | |
| Comparative | EC/DEC/FEC | Compound 1 | 1.3 | 69 |
| Example 1-2 | (2/2/1) | | | |
| Comparative | EC/DEC/FEC | Compound 1 | 1.5 | 61 |
| Example 1-3 | (2/2/1) | | | |
| Comparative | EC/DEC/FEC | Compound 1 | 2.0 | 55 |
| Example 1-4 | (2/2/1) | | | |

As shown in Table 1, it was noted that in Examples 1-1 to 1-5, the ambient temperature molten salt was contained in the electrolytic solution, and therefore, an extremely favorable cycle characteristic was obtained. Furthermore, it was noted that when the amount of the ambient temperature molten salt was not more than 1% by mass in terms of a mass ratio to the negative electrode active material, the effect was revealed depending upon the addition amount. As the amount of the ambient temperature molten salt increased exceeding 1% by mass, the amount of the decomposed film to be formed at the interface of the negative electrode active material increased, resulting in a lowering of the cycle characteristic.

### Examples 2-1 to 2 to 14

As Examples 2-1 to 2-14, secondary batteries having the same configuration as in Example 1-3 were prepared, except that the kind of the ambient temperature molten salt was different. Each of these secondary batteries of Examples 2-1 to 2-14 was subjected to charge and discharge and examined with respect to the discharge capacity retention rate in the same manner as in Example 1-3. The results obtained are shown in Table 2.

TABLE 2

| | | | Amount of ambient | Retention |
|---|---|---|---|---|
| | Composition | Kind of ambient | temperature molten salt | rate after |
| | of organic | temperature | (ratio to negative electrode | 100 cycles |
| | solvent | molten salt | active material) (% by mass) | (%) |
| Example 2-1 | EC/DEC/FEC | Compound 2 | 0.5 | 85 |
| | (2/2/1) | | | |
| Example 2-2 | EC/DEC/FEC | Compound 3 | 0.5 | 83 |
| | (2/2/1) | | | |
| Example 2-3 | EC/DEC/FEC | Compound 4 | 0.5 | 82 |
| | (2/2/1) | | | |
| Example 2-4 | EC/DEC/FEC | Compound 5 | 0.5 | 82 |
| | (2/2/1) | | | |
| Example 2-5 | EC/DEC/FEC | Compound 6 | 0.5 | 85 |
| | (2/2/1) | | | |
| Example 2-6 | EC/DEC/FEC | Compound 7 | 0.5 | 82 |
| | (2/2/1) | | | |
| Example 2-7 | EC/DEC/FEC | Compound 8 | 0.5 | 85 |
| | (2/2/1) | | | |
| Example 2-8 | EC/DEC/FEC | Compound 9 | 0.5 | 84 |
| | (2/2/1) | | | |
| Example 2-9 | EC/DEC/FEC | Compound 10 | 0.5 | 85 |
| | (2/2/1) | | | |
| Example 2-10 | EC/DEC/FEC | Compound 11 | 0.5 | 86 |
| | (2/2/1) | | | |
| Example 2-11 | EC/DEC/FEC | Compound 12 | 0.5 | 83 |
| | (2/2/1) | | | |
| Example 2-12 | EC/DEC/FEC | Compound 13 | 0.5 | 79 |
| | (2/2/1) | | | |
| Example 2-13 | EC/DEC/FEC | Compound 14 | 0.5 | 78 |
| | (2/2/1) | | | |
| Example 2-14 | EC/DEC/FEC | Compound 15 | 0.5 | 78 |
| | (2/2/1) | | | |

As shown in Table 2, it was noted that in Example 2-14, an extremely favorable cycle characteristic was obtained. It was noted that in Examples 2-1 to 2-11 in which the ambient temperature molten salt had a quaternary ammonium salt cation structure, the effect was large. It may be considered that this was caused due to the fact that a good decomposed film was formed at the interface of the negative electrode material.

### Examples 3-1 to 3-6 and Comparative Examples 3-1 to 3-6

As Examples 3-1 to 3-6 and Comparative Examples 3-1 to 3-6, secondary batteries having the same configuration as in Example 1-3 were prepared, except that the kind of the ambient temperature molten salt was different. Each of these secondary batteries of Examples 3-1 to 3-6 and Comparative Examples 3-1 to 3-6 was subjected to charge and discharge and examined with respect to the discharge capacity retention rate in the same manner as in Example 1-3. The results obtained are shown in Table 3.

TABLE 3

| | | | Amount of ambient | Retention |
|---|---|---|---|---|
| | Composition | Kind of ambient | temperature molten salt | rate after |
| | of organic | temperature | (ratio to negative electrode | 100 cycles |
| | solvent | molten salt | active material) (% by mass) | (%) |
| Example 3-1 | EC/DEC/FEC | Compound 1 | 0.5 | 85 |
| | (1/1/1) | | | |
| Example 3-2 | EC/DEC/FEC | Compound 1 | 0.5 | 84 |
| | (3/3/1) | | | |
| Example 3-3 | EC/DEC/FEC | Compound 1 | 0.5 | 88 |
| | (1/1/2) | | | |
| Example 3-4 | EC/EMC/FEC | Compound 1 | 0.5 | 82 |
| | (2/2/1) | | | |
| Example 3-5 | EC/DMC/FEC | Compound 1 | 0.5 | 88 |
| | (2/2/1) | | | |
| Example 3-6 | EC/DEC/PC | Compound 1 | 0.5 | 77 |
| | (3/3/1) | | | |
| Comparative | EC/DEC/FEC | Compound 1 | 0 | 70 |
| Example 3-1 | (1/1/1) | | | |
| Comparative | EC/DEC/FEC | Compound 1 | 0 | 67 |
| Example 3-2 | (3/3/1) | | | |
| Comparative | EC/DEC/FEC | Compound 1 | 0 | 72 |
| Example 3-3 | (1/1/2) | | | |
| Comparative | EC/EMC/FEC | Compound 1 | 0 | 67 |
| Example 3-4 | (2/2/1) | | | |
| Comparative | EC/DMC/FEC | Compound 1 | 0 | 71 |
| Example 3-5 | (2/2/1) | | | |
| Comparative | EC/DEC/PC | Compound 1 | 0 | 62 |
| Example 3-6 | (3/3/1) | | | |

As shown in Table 3, in all of Examples 3-1 to 3-6, by containing the ambient temperature molten salt in an amount of 0.5% by mass relative to the mass of the negative electrode material within the battery in the electrolytic solution, an extremely excellent cycle characteristic was obtained.

### Examples 4-1 to 4-11

Secondary batteries having the same configuration as in Example 1-3 were prepared, except that the mixing method of the ambient temperature molten salt was changed.

As Examples 4-1 to 4-6, batteries were prepared using an ambient temperature molten salt-containing negative electrode prepared by mixing an ambient temperature molten salt at the negative electrode slurry stage in place of mixing the ambient temperature molten salt with the electrolytic solution and drying the mixture as it was. At that time, by injecting the electrolytic solution, the ambient temperature molten salt contained in the negative electrode is diffused into the electrolytic solution.

As Examples 4-7 to 4-10, batteries were prepared using an ambient temperature molten salt-containing positive electrode prepared by mixing an ambient temperature molten salt at the positive electrode slurry stage in place of the case as in the negative electrode and drying the mixture as it was. At that time, by injecting the electrolytic solution, the ambient temperature molten salt contained in the positive electrode is diffused into the electrolytic solution.

As Example 4-11, a battery was prepared by containing the same amount of an ambient temperature molten salt in both of a positive electrode and a negative electrode. The manufacturing methods of the positive electrode and the negative electrode are the same as those in Example 4-3 and Example 4-8, respectively.

Each of these secondary batteries of Examples 4- to 4-11 was subjected to charge and discharge and examined with respect to the discharge capacity retention rate in the same manner as in Example 1-3. The results obtained are shown in Table 4.

TABLE 4

| | | | | | Amount of ambient |
|---|---|---|---|---|---|
| | | | | | temperature molten |
| | | | Amount of ambient | | salt (ratio |
| | | | temperature molten | | relative to the |
| | | Kind of | salt (ratio to | Retention | total of |
| | | ambient | negative electrode | rate after | electrolytic |
| | | temperature | active material) | 100 cycles | solution) |
| | Addition method | molten salt | (% by mass) | (%) | (% by mass) |
| Example 4-1 | Added to negative | Compound 1 | 0.05 | 80 | |
| | electrode | | | | |
| Example 4-2 | Added to negative | Compound 1 | 0.1 | 86 | |
| | electrode | | | | |
| Example 4-3 | Added to negative | Compound 1 | 0.5 | 89 | 0.30 |
| | electrode | | | | |
| Example 4-4 | Added to negative | Compound 1 | 0.8 | 85 | |
| | electrode | | | | |
| Example 4-5 | Added to negative | Compound 1 | 1.0 | 81 | 0.60 |
| | electrode | | | | |
| Example 4-6 | Added to positive | Compound 1 | 0.05 | 73 | |
| | electrode | | | | |
| Example 4-7 | Added to positive | Compound 1 | 0.1 | 80 | |
| | electrode | | | | |
| Example 4-8 | Added to positive | Compound 1 | 0.5 | 83 | 0.20 |
| | electrode | | | | |
| Example 4-9 | Added to positive | Compound 1 | 0.8 | 81 | |
| | electrode | | | | |
| Example 4- | Added to positive | Compound 1 | 1.0 | 75 | 0.40 |
| 10 | electrode | | | | |
| Example 4- | Added to negative | Compound 1 | 1.0 | 90 | 0.50 |
| 11 | electrode & | | | | |
| | Added to positive | | | | |
| | electrode | | | | |

### Composition of Organic Solvent: EC/DEC/FEC (2/2/1)

As shown in Table 4, it was noted that in Examples 4-1 to 4-11, an extremely favorable cycle characteristic was obtained.

The kind of each of the ambient temperature molten salts used in the Examples is shown in Table 5.

TABLE 5

| | |
|---|---|
| Compound 1 | Trimethylpropylammonium bis(trifluoromethylsulfonyl)imide |
| Compound 2 | Trimethylhexylammonium bis(trimethylfluorosulfonyl)imide |
| Compound 3 | N,N-Diethyl-N-methyl-N-(2-methoxyethyl)ammonium bis(trifluoromethylsulfonyl)imide |
| Compound 4 | N,N-Diethyl-N-methyl-N-(2-methoxyethyl)ammonium tetrafluoroborate |
| Compound 5 | N-Methyl-N-methoxymethylpyrrolidinium tetrafluoroborate |
| Compound 6 | N-Methyl-N-methoxymethylpyrrolidinium bis(trifluoromethylsulfonyl)imide |
| Compound 7 | N-Methyl-N-methoxymethylpiperidinium tetrafluoroborate |
| Compound 8 | N-Methyl-N-methoxymethylpiperidinium bis(trifluoromethylsulfonyl)imide |
| Compound 9 | N-Methyl-N-propylpiperidinium bis(trifluoromethylsulfonyl)imide |
| Compound 10 | N-Methyl-N-propylpiperidinium bis(fluorosulfonyl)imide |
| Compound 11 | N-Methyl-N-propylpyrrolidinium bis(trifluoromethylsulfonyl)imide |
| Compound 12 | N-Methyl-N-propylpyrrolidinium bis(fluorosulfonyl)imide |
| Compound 13 | Ethylmethylimidazolium bis(trifluoromethylsulfonyl)imide |
| Compound 14 | Ethylmethylimidazolium tetrafluoroborate |
| Compound 15 | Ethylmethylimidazolium bis(fluorosulfonyl)imide |

While the present invention has been described with reference to the foregoing embodiments and working examples, it should not be construed that the present invention is limited to these embodiments and working examples, and various modifications can be made.

What is claimed is:

1. A nonaqueous electrolytic solution battery comprising:
a positive electrode;
a negative electrode; and
a nonaqueous electrolytic solution, wherein
the nonaqueous electrolytic solution contains an ambient temperature molten salt; and
the content of the ambient temperature molten salt is not more than 1.0% by mass relative to the total of negative electrode active materials.

2. The nonaqueous electrolytic solution battery according to claim 1, wherein
the ambient temperature molten salt contains a tertiary or quaternary ammonium salt composed of a tertiary or quaternary ammonium cation and a fluorine atom-containing anion.

3. The nonaqueous electrolytic solution battery according to claim 2, wherein
the tertiary or quaternary ammonium cation has a structure represented by any one of the following formulae (1) to (5): 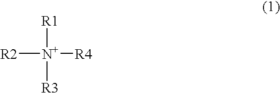
wherein each of R1, R2, R3 and R4 represents an aliphatic group, an aromatic group, a heterocyclic group or a group in which a part of the elements of any one of these groups is substituted with a substituent, 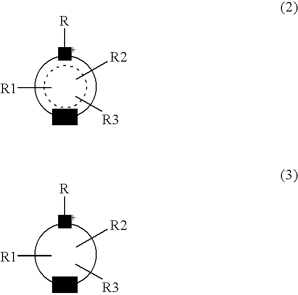
wherein m is from 4 to 5; each of R1, R2 and R3 represents an alkyl group or an alkoxy group each having from 1 to 5 carbon atoms, an amino group or a nitro group and may be the same or different; each of R1, R2 and R3 may be absent; R represents a hydrogen atom or an alkyl group having from 1 to 5 carbon atoms; and the nitrogen atom is a tertiary or quaternary ammonium cation, and 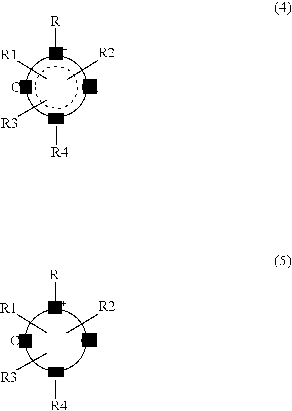
wherein m is from 0 to 2; (m+n) is from 3 to 4; each of R1, R2 and R3 represents an alkyl group or an alkoxy group each having from 1 to 5 carbon atoms, an amino group or a nitro group and may be the same or different; each of R1, R2 and R3 may be absent; R4 represents an alkyl group having from 1 to 5 carbon atoms; R represents a hydrogen atom or an alkyl group having from 1 to 5 carbon atoms; and the nitrogen atom is a tertiary or quaternary ammonium cation.

4. The nonaqueous electrolytic solution battery according to claim 3, wherein
the cation having a structure represented by any one of the formulae (1) to (5) is an alkyl quaternary ammonium cation, a piperidinium cation or a pyrrolidinium cation.

5. A nonaqueous electrolytic solution composition comprising:
an ambient temperature molten salt in an amount of not more than 1.0% by mass relative to the total of negative electrode active materials.
